(19) United States
(12) Patent Application Publication
(10) Pub. No.: US 2011/0254887 A1
(43) Pub. Date: Oct. 20, 2011

(54) CAPACITIVE LOAD DRIVING DEVICE AND LIQUID JET APPARATUS

(75) Inventors: Noritaka IDE, Shiojiri-shi (JP); Kunio TABATA, Shiojiri-shi (JP); Shinichi MIYAZAKI, Suwa-shi (JP); Atsushi OSHIMA, Shiojiri-shi (JP); Hiroyuki YOSHINO, Matsumoto-shi (JP)

(73) Assignee: SEIKO EPSON CORPORATION, Tokyo (JP)

(21) Appl. No.: 13/084,707

(22) Filed: Apr. 12, 2011

(30) Foreign Application Priority Data
Apr. 15, 2010 (JP) 2010-093756

(51) Int. Cl. B41J 29/38; G05F 1/10

(52) U.S. Cl. 347/10; 327/111

(57) ABSTRACT

A capacitive load driving device includes a drive waveform generator that generates a drive waveform signal, a subtractor that outputs a difference signal between the drive waveform signal and a feedback signal, a modulator that pulse-modulates the difference signal to output a modulated signal, a digital power amplifier that amplifies the modulated signal to output an amplified digital signal, a low pass filter that smoothes the amplified digital signal to output a drive signal for a capacitive load, a feedback circuit that outputs the feedback signal obtained from the drive signal, and an adjusting section that adjusts frequency characteristics of the feedback circuit based on capacitance of the capacitive load to be driven.

This application claims priority to Japanese Patent Application No. 2010-093756, filed Apr. 15, 2010, the entirety of which is hereby incorporated by reference.

### BACKGROUND

1. Technical Field

The present invention relates to a capacitive load driving device that drives a capacitive load such as a piezoelectric element by applying a drive signal to the capacitive load, and to a liquid jet apparatus that ejects liquid by applying a drive signal to an actuator, which is the capacitive load.

2. Related Art

In a case where a digital power amplifier amplifies a drive waveform signal constituted of predetermined voltage waveforms to generate a drive signal to be fed to actuators constituted of capacitive loads, a modulator pulse-modulates the drive waveform signal to obtain a modulated signal, then the digital power amplifier amplifies the modulated signal to obtain an amplified digital signal. Then, a low pass filter smoothes the amplified digital signal to obtain the drive signal.

A capacitive load driving device has actuators connected. The actuators are capacitive loads such as piezoelectric elements. When the number of actuators driven by the capacitive load driving device varies, frequency characteristics of a filter constituted of a low pass filter and capacitance of the actuators driven also vary. As a result, waveforms of the drive signal may be adversely changed. To resolve this problem, a driving device for capacitive load in US2009/0140780A is provided with capacitance (also referred to as a dummy load) equivalent to the capacitance of the actuators disposed in parallel to each of the actuators. Those actuators that are driven are connected to a driving circuit, but for those actuators that are not driven, corresponding dummy loads are connected to the driving circuit. As such, the frequency characteristics of the filter constituted of the low pass filter, as well as the capacitance of the actuators and dummy loads are made constant. It is noted that a frequency on which a modulator pulse-modulates is referred to as a modulation frequency or carrier frequency.

However, the driving device for capacitive load in US 2009/0140780A requires larger power consumption because the dummy loads consume power instead even when the corresponding actuators are not driven.

### SUMMARY

The invention provides a capacitive load driving device and a liquid jet apparatus in which variance in frequency characteristics of a filter constituted of a low pass filter and capacitance of actuators driven is suppressed without using dummy loads.

A capacitive load driving device according to an aspect of the invention includes a drive waveform generator that generates a drive waveform signal, a subtractor that outputs a difference signal between the drive waveform signal and a feedback signal, a modulator that pulse-modulates the difference signal to output a modulated signal, a digital power amplifier that amplifies the modulated signal to output an amplified digital signal, a low pass filter that smoothes the amplified digital signal to output a drive signal for a capacitive load, a feedback circuit that outputs the feedback signal obtained from the drive signal, and an adjusting section that adjusts frequency characteristics of the feedback circuit based on capacitance of the capacitive load to be driven.

According to the aspect of the invention, as the drive signal is fed back from the feedback circuit as the feedback signal, the capacitive load driving device adjusts the frequency characteristics of the feedback circuit based on the capacitance of the capacitive load to be driven. As such, variance in frequency characteristics of a filter constituted of the low pass filter and the capacitance of the driven capacitive load is suppressed without using dummy loads.

In the capacitive load driving device of the aspect of the invention, the capacitive load driving device further includes a second feedback circuit with different frequency characteristics from the feedback circuit, and the adjusting section may switch between the feedback circuit and the second feedback circuit based on the capacitance of the capacitive load to be driven.

Accordingly, the capacitive load driving device may switch between the feedback circuit and the second feedback circuit so as to largely change the frequency characteristics. Also accordingly, large variance in the frequency characteristics of the filter constituted of the low pass filter and capacitance of the capacitive load to be driven is suppressed.

Furthermore, in the capacitive load driving device of the aspect of the invention, the feedback circuit may be configured to include a first element and a second element that are used to adjust frequency characteristics, and the adjusting section may switch between the first element and the second element based on the capacitance of the capacitive load to be driven.

Accordingly, the capacitive load driving device switches between the elements constituting the feedback circuit so as to change the frequency characteristics of the feedback circuit. Hence, the feedback circuit can be made compact.

In the capacitive load driving device of the aspect of the invention, the feedback circuit may be configured to include a gain adjusting section that adjusts gain characteristics relative to a frequency, and the adjusting section may adjust the gain characteristics of the feedback circuit based on the capacitance of the capacitive load to be driven.

Hence, the feedback circuit in the capacitive load driving device can be made compact.

A liquid jet apparatus according to another aspect of the invention is a liquid jet apparatus that ejects liquid. The liquid jet apparatus includes the capacitive load driving device and the actuator that is a capacitive load to be driven by the capacitive load driving device.

According to this aspect of the invention, as the drive signal is fed back from the feedback circuit as the feedback signal, the liquid jet apparatus adjusts the frequency characteristics of the feedback circuit based on the capacitance of the capacitive load being driven. As such, variance in frequency characteristics of a filter constituted of the low pass filter and the capacitance of the driven capacitive load is suppressed without using dummy loads. Hence, the aspect of the invention enables liquid ejection in higher precision relative to related art.

### BRIEF DESCRIPTION OF THE DRAWINGS

The invention will be described with reference to the accompanying drawings, wherein like numbers reference like elements:

FIG. 1 is an elevational view showing an inkjet printer employing a capacitive load driving device according to a first embodiment of the invention.

FIG. 2 is a plan view of an inkjet head and its periphery.

FIG. 3 is a block diagram of a control device of the inkjet printer.

FIG. 4 is an explanatory diagram illustrating a drive signal for an actuator, which is a capacitive load.

FIG. 5 is a block diagram of a switching controller.

FIG. 6 is a block diagram showing an actuator driving circuit according to the first embodiment.

FIG. 7 is a flowchart of a calculation process executed in an adjusting section of FIG. 6.

FIG. 8 is a timing chart illustrating the number of actuators driven and feedback circuit selection signals.

FIGS. 9A and 9B are diagrams illustrating an effect on frequency characteristics of the driving circuit of FIG. 6.

FIG. 10 is a diagram illustrating frequency characteristics of a driving circuit without a feedback circuit.

FIG. 11 is a block diagram of an example driving circuit with a single feedback circuit.

FIG. 12 is a diagram illustrating an effect on frequency characteristics of the driving circuit of FIG. 11.

FIG. 13 is a diagram illustrating frequency characteristics of a filter constituted of a low pass filter and capacitance of actuators as the number of actuators driven changes.

FIGS. 14A and 14B are diagrams illustrating an effect on frequency characteristics of the driving circuit of FIG. 11 as the number of actuators driven changes.

FIGS. 15A and 15B are diagrams illustrating an effect on frequency characteristics of the driving circuit of FIG. 11 as the number of actuators driven changes.

FIG. 16 is a block diagram showing an actuator driving circuit according to a second embodiment of the invention.

FIGS. 17A, 17B and 17C are explanatory diagrams illustrating how a feedback circuit is designed.

FIGS. 18A and 18B are block diagrams showing an actuator driving circuit according to third and fourth embodiments of the invention.

FIG. 19 is a block diagram showing an actuator driving circuit according to a fifth embodiment of the invention.

FIGS. 20A and 20B are diagrams that illustrate an effect on frequency characteristics of the driving circuit of FIG. 19.

FIG. 21 is a block diagram showing an actuator driving circuit according to a sixth embodiment of the invention.

FIGS. 22A and 22B are diagrams illustrating an effect on frequency characteristics of the driving circuit of FIG. 21.

FIG. 23 is a block diagram showing an actuator driving circuit according to a seventh embodiment of the invention.

FIG. 24 is a block diagram showing an actuator driving circuit according to an eighth embodiment of the invention.

FIGS. 25A and 25B are explanatory diagrams illustrating how current is detected in the actuator driving circuit of FIG. 24.

### DESCRIPTION OF EXEMPLARY EMBODIMENTS

A first embodiment of a capacitive load driving device of the invention will hereinafter be explained.

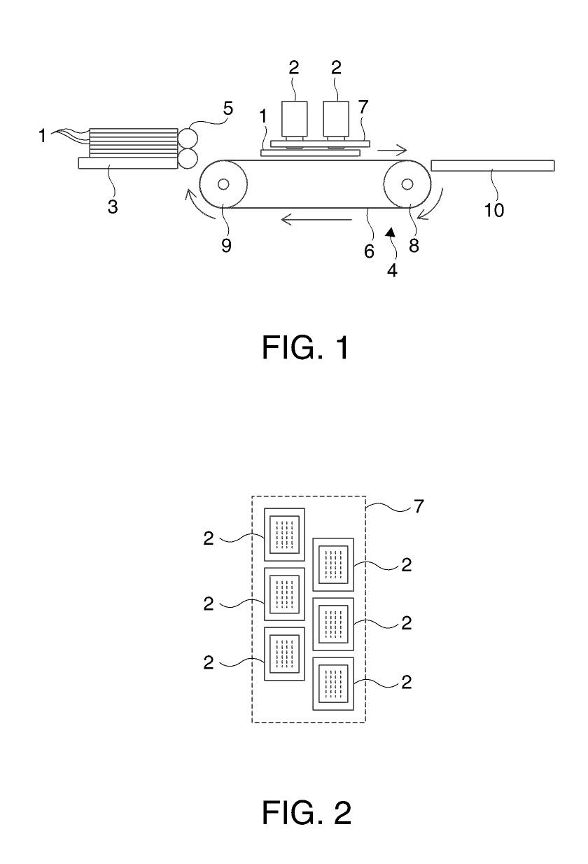

FIG. 1 is an elevational view showing an inkjet printer of the first embodiment. Shown in FIG. 1 is a line-head inkjet printer, on which a print medium 1 is conveyed from left to right of the drawing along the direction of the arrows, and is printed in a print area in the middle of the conveying path.

Reference numeral 2 denotes inkjet heads disposed on the upstream side in the conveying direction of the print medium 1, which are fixed individually to a head fixing plate 7 in such a manner as to form two lines in the print medium conveying direction and to be arranged in a direction perpendicular to the print medium conveying direction. The inkjet head 2 is provided with a number of nozzles on its under surface (nozzle surface). The nozzles are, as shown in FIG. 2, disposed in lines in a direction perpendicular to the print medium conveying direction, for each ink color to be ejected. Each line of the nozzles is hereinafter referred to as a nozzle line. The direction of the nozzle line is referred to as a nozzle line direction. All the nozzle lines of the inkjet heads 2 disposed in a direction perpendicular to the print medium conveying direction constitute a line head that covers an entire width relative to the direction perpendicular to the conveying direction of the print medium 1.

The inkjet head 2 is supplied with ink of four colors of, for example, yellow (Y), magenta (M), cyan (C), and black (K), from unshown ink tanks of respective colors via ink supply tubes.

Ejecting necessary amount of ink from the nozzles provided on the inkjet head 2 onto a particular location forms microscopic dots on the print medium 1. Performing the same for each color enables printing in one-pass by simply passing through the print medium 1 once on a conveyer 4. In this embodiment, a piezoelectric method is used to eject ink from a nozzle of the inkjet head 2. In the piezoelectric method, applying a drive signal to a piezoelectric element, which is an actuator, causes a diaphragm in the pressure chamber to deform and changes the volume in the pressure chamber to cause pressure variation, thereby causing ink inside the pressure chamber to be ejected from the nozzle. In the piezoelectric method, changing the wave height or increasing or decreasing gradient of voltage rapidly or slowly, of the driving signal, enables control in the amount of ink ejection. It should be noted that the invention is applicable to other ink ejection methods besides the piezoelectric method.

Beneath the inkjet head 2, the conveyer 4 is disposed to convey the print medium 1 in the conveying direction. The conveyer 4 is constituted of a conveying belt 6 wound around a driving roller 8 and a driven roller 9. To the driving roller 8, an unshown electric motor is connected. On the internal side of the conveying belt 6, an unshown absorption device that absorbs the print medium 1 on a surface of the conveying belt 6, is provided. For the absorption device, for example, an air suction device that absorbs the print medium 1 on the conveying belt 6 using negative pressure, or an electrostatic absorption device that absorbs the print medium 1 on the conveying belt 6 using electrostatic force. A pickup roller 5 picks up one print medium 1 from a feeder 3 to feed the medium onto the conveying belt 6, and as the electric motor turns and drives the drive roller 8, the conveying belt 6 turns in the print medium conveying direction, onto which the print medium 1 is absorbed with the absorption device to be conveyed. While the print medium 1 is conveyed, ink is ejected from the inkjet heads 2 for printing. When printing is completed on the print medium 1, the print medium 1 is discharged on a catch tray 10 in the downstream side of the conveying direction. On the conveying belt 6, a print reference signaling device constituted of a linear encoder, for example, is provided. The print reference signaling device outputs a pulse signal corresponding to the requested resolution. Based on the pulse signal, a driving circuit, to be explained later below, outputs a drive signal for the actuator to eject ink of a predetermined color on a predetermined location of the print medium 1. The ejected ink forms dots to draw a predetermined image on the print medium 1.

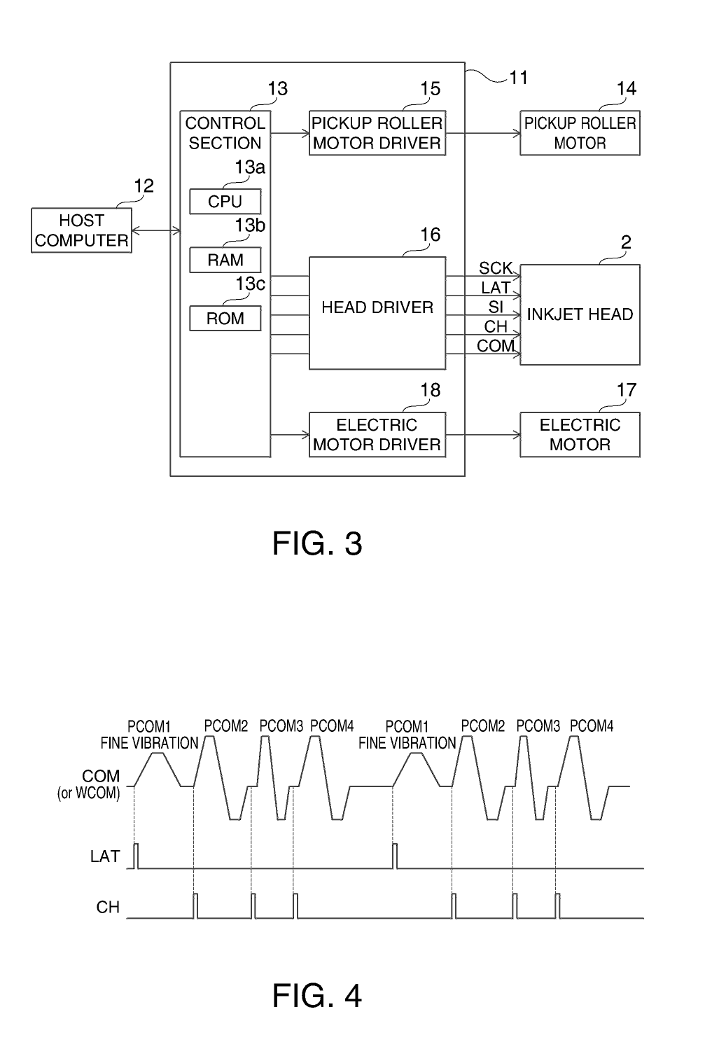

On the inkjet printer of the present embodiment, a control device 11 is provided to control the inkjet printer. The control device 11, as shown in FIG. 3, is configured to include a control section 13, a pickup roller motor driver 15, a head driver 16, and an electrical motor driver 18. The control section 13 is configured to include a computer system that reads print data input from a host computer 12 and that executes a calculation process such as printing process based on the print data. The pickup roller motor driver 15 controls a pickup roller motor 14 connected to the pickup roller 5. The head driver 16 controls the inkjet head 2. The electrical motor driver 18 controls an electrical motor 17 connected to the driving roller 8.

The control section 13 is provided with a CPU (Central Processing Unit) 13a, a RAM (Random Access Memory) 13b, and a ROM (Read-Only Memory) 13c. The CPU 13a executes various processes such as a printing process. The RAM 13b temporarily stores various data including print data that has been input or other data associated with executing the printing process of the print data, or temporarily implement a program for printing process or the like. The ROM 13c is constituted of a nonvolatile semiconductor memory that stores a control program or the like that is executed in the CPU 13a. In the control section 13 upon receiving print data (image data) from the host computer 12, the CPU 13a executes a predetermined process on the print data to calculate nozzle selection data (drive pulse selection data) that indicates which nozzle ejects ink or an amount of ink to be ejected. The CPU 13a outputs a control signal and a drive signal to the pickup roller motor driver 15, the head driver 16, and the electric motor driver 18 based on the print data, drive pulse selection data, or input data from various sensors. The control signal and the drive signal operate the pickup roller motor 14, the electrical motor 17, and an actuator of the inkjet head 2 to pick up, convey, discharge the print medium 1 and execute the printing process on the print medium 1. The elements constituting the control section 13 are electrically connected via an unshown bus.

FIG. 4 is a drive signal supplied to the inkjet head 2 from the head driver 16, and is an example of a drive signal COM for driving a piezoelectric element, which is an actuator. In this embodiment, the drive signal COM is a signal, the voltage of which changes with respect to the mid-voltage. The drive signal COM is a drive pulse PCOM connected in time-series, which is a unit drive signal to drive the actuator for ejecting ink. A rising part of the drive pulse PCOM is in a status where the volume of the pressure chamber connected to a nozzle is expanded to draw in the ink. A lower part of the drive pulse PCOM is in a status where the volume of the pressure chamber is reduced to push out the ink. As a result of the ink being pushed out, the ink is ejected from the nozzle.

Increasing or decreasing the gradient of voltage and changing the wave height of the drive pulse PCOM, which has a trapezoidal shape of voltage waveform, enables adjustment of an ink amount to be drawn in, a speed of the draw-in, an ink amount to be pushed out, and a speed of the push-out. Such adjustment of the ink ejection amount allows to form dots in various sizes. In the case where drive pulses PCOM are connected in time-series, a single drive pulse PCOM may be selected to be supplied to an actuator 19, or a series of drive pulses PCOM may be supplied to the actuator 19. It is noted that the drive pulse PCOM1 shown in the left end of FIG. 4 only draws in the ink and does not push out the ink. This status is referred to as fine vibration, employed to inhibit thickening in the nozzle without ejecting any ink.

In the inkjet head 2, other control signals besides the drive signal COM are input from the control device of FIG. 3. One is a drive pulse selection data SI, indicating which drive pulse PCOM is to be selected from various drive pulses PCOM based on the print data. Some others are a latch signal LAT and a channel signal CH for communicating the drive signal COM to the actuator of the inkjet head 2 based on the drive pulse selection data SI after each nozzle receives nozzle selection data. The other is a clock signal SCK for sending the drive pulse selection data SI as a serial signal to the inkjet head 2. Hereinafter, for driving the actuator 19, a minimum unit of a drive signal is referred to as a drive pulse PCOM, and a series of drive pulses PCOM connected in time-series is referred to as a drive signal COM. At the latch signal LAT, a series of drive signals COM starts to be output, and a drive pulse PCOM is output at every channel signal CH.

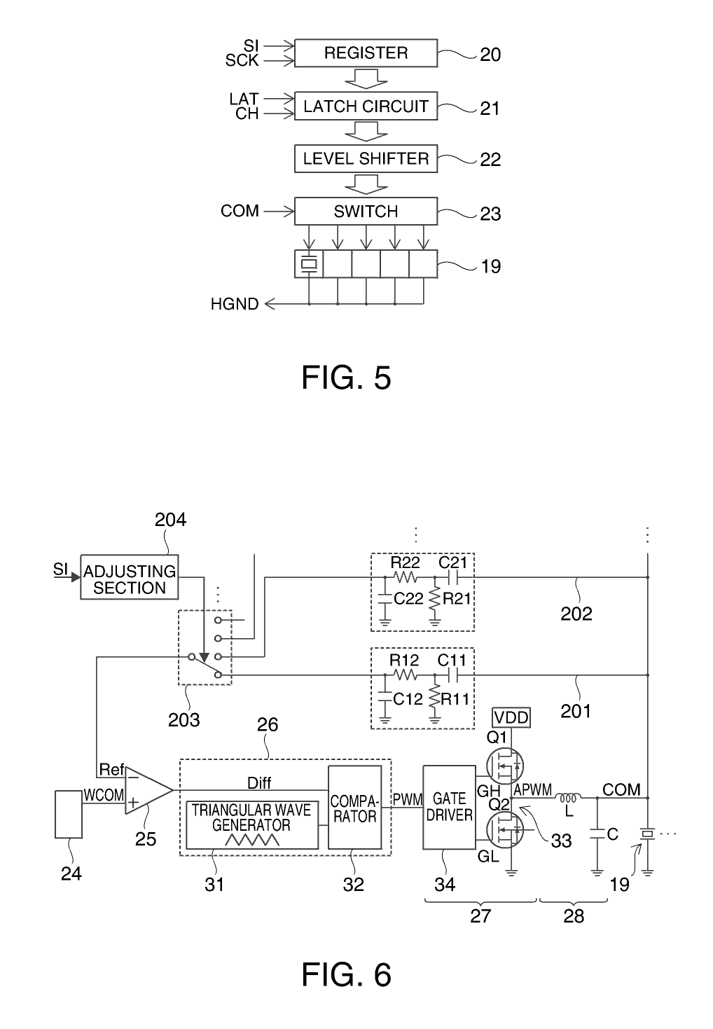

FIG. 5 shows a specific configuration of a switching controller inside the inkjet head 2 for supplying the drive signal COM (drive pulse PCOM) to the actuator 19. The switching controller is configured to include a register 20, a latch circuit 21, and a level shifter 22. The register 20 stores the drive pulse selection data SI that indicates the actuator 19 which corresponds to the nozzle that is to eject ink. The latch circuit 21 temporarily stores data of the register 20. The level shifter 22 shifts the level of the output from the latch circuit 21 to supply the output to a switch 23, thereby communicating the drive signal COM (drive pulse PCOM) to the actuator 19.

The level shifter 22 shifts a voltage level to be able to turn the switch 23 on or off. Because the drive signal COM (drive pulse PCOM) is of high voltage relative to the output voltage of the latch circuit 21 and the operational voltage range for the switch 23 is also set high, a level shift of the voltage is necessary. The actuator 19 that is switched on with the switch 23 by the level shifter 22 is communicated to the drive signal COM (drive pulse PCOM) at a predetermined connection timing based on the drive pulse selection data SI. After the drive pulse selection data SI is stored in the latch circuit 21, the next print information is input to the register 20 and the stored data in the latch circuit 21 is orderly updated according to timings of ink ejection. In FIG. 5, HGND denotes a ground end of the actuator 19. After the switch 23 cuts off (the switch 23 is turned off) the actuator 19 from the drive signal COM (drive pulse PCOM), the actuator 19 holds the input voltage at the level immediately before the cut-off. To put it in another way, the actuator 19 is a capacitive load.

FIG. 6 is a schematic configuration of a driving circuit for the actuator 19. The driving circuit is disposed in the head driver 16 of the control device 11. The driving circuit is configured to include a drive waveform generator 24, a subtractor 25, a modulator 26, a digital power amplifier 27, a low pass filter 28, a first feedback circuit 201, a second feedback circuit 202, a switch 203, and an adjusting section 204. The drive waveform generator 24 generates a drive waveform signal WCOM, which is a source of the drive signal COM (drive pulse PCOM), or in other words, the base of a signal that controls the actuator 19, based on an initially-stored drive waveform data DWCOM. The subtractor 25 subtracts a feedback signal Ref from the drive wave form signal WCOM to output a difference signal Diff. The modulator 26 pulse-modulates the difference signal Diff to output a modulated signal PWM. The digital power amplifier 27 amplifies the modulated signal PWM to output an amplified digital signal APWM. The low pass filter 28 smoothes the amplified digital signal APWM to output a drive signal COM to the actuator 19. The first feedback circuit 201 feeds back the drive signal COM to the subtractor 25. The second feedback circuit 202 feeds back the drive signal COM to the subtractor 25. The switch 203 connects the first feedback circuit 201 or the second feedback circuit 202 to the subtractor 25. The adjusting section 204 controls the switch 203 based on the drive pulse selection data SI. Only two feedback circuits, namely the first feedback circuit 201 and the second feedback circuit 202 are provided, however, the number of feedback circuits is not limited to the number mentioned herein. Three or more number of feedback circuits may be employed.

The drive waveform generator 24 converts the drive waveform data DWCOM in digital form to a voltage signal and outputs after holding for a predetermined sampling period. The subtractor 25 is an analogue subtractor circuit generally used with a proportional constant resistor interposed therewith. The modulator 26 is a well-known Pulse Width Modulation (PWM) circuit. The PWM circuit includes a triangular wave generator 31 and a comparator 32. The triangular wave generator 31 outputs a triangular-wave signal on a predetermined frequency. The comparator 32 compares the triangular-wave signal to the difference signal Diff to output a modulated signal PWM, a pulse duty of which turns on duty when the difference signal Diff is larger than the triangular-wave signal. Some other pulse-modulation circuits may be used for the modulator 26 including a pulse-density-modulation circuit (PDM) or the like. The drive waveform generator 24, the subtractor 25, and the modulator 26 may also be configured by calculation processes. For example, a program in the control section 13 of the control device 11 may be executed to configure the drive waveform generator 24, the subtractor 25, and the modulator 26.

As shown in FIG. 6, the digital power amplifier 27 is configured to include a half bridge output stage 33 and a gate driver 34. The half bridge output stage 33 is constituted of a high side switching element Q1 and a low side switching element Q2 for amplifying power. The gate driver 34 controls gate-source signals GH and GL of the high side switching element Q1 and the low side switching element Q2 based on the modulated signal PWM from the modulator 26. In the digital power amplifier 27, when the modulated signal is at the high level, the gate-source signal GH of the high side switching element Q1 turns high level and the gate-source signal GL of the low side switching element Q2 turns low level. In other words, the high side switching element Q1 turns on, and the low side switching element Q2 turns off. As a result, an output voltage Va from the half bridge output stage 33 becomes a supplying voltage VDD. On the other hand, when the modulated signal is at the low level, the gate-source signal GH of the high side switching element Q1 turns low level, and the gate-source signal GL of the low side switching element Q2 turns high level. In other words, the high side switching element Q1 turns off, and the low side switching element Q2 turns on. As a result, an output voltage Va from the half bridge output stage 33 becomes 0.

When the high side switching element Q1 and the low side switching element Q2 are digitally driven, the current flows in the switching element that is on, but a resistance between the drain and source is very small and hence there is very little loss. Also, when the high side switching element Q1 and the low side switching element Q2 are digitally driven, no current flows in the switching element that is off and hence there is no loss. Loss in the digital power amplifier 27 is very little, and compact switching elements like MOSFET may be used.

As shown in FIG. 6, the low pass filter 28 is a secondary low pass filter constituted of an inductor L and a capacitor C. The low pass filter 28 attenuates and removes the modulation frequency component caused in the modulator 26, or the signal amplitude of the frequency component in the pulse modulation, to output the drive signal COM (drive pulse PCOM) to the actuator 19.

The first feedback circuit 201 and the second feedback circuit 202 are constituted of a high pass filter and a low pass filter connected in series, the high pass filter constituted of a capacitor and a ground resistance, and the low pass filter constituted of a resistance and a ground capacitor. As generally known, varying a resistance or capacitance value in circuit elements changes frequency characteristics in a circuit. The frequency characteristics of the first feedback circuit 201 and the frequency characteristics of the second feedback circuit 202 are different. Configuration of the frequency characteristics of the first feedback circuit 201 and the second feedback circuit 202 will be described later below. The switch 203 switches between the first feedback circuit 201 and the second feedback circuit 202 according to the first feedback circuit selection signal or the second feedback circuit selection signal from the adjusting section 204 to connect to a negative feedback terminal of the subtractor 25.

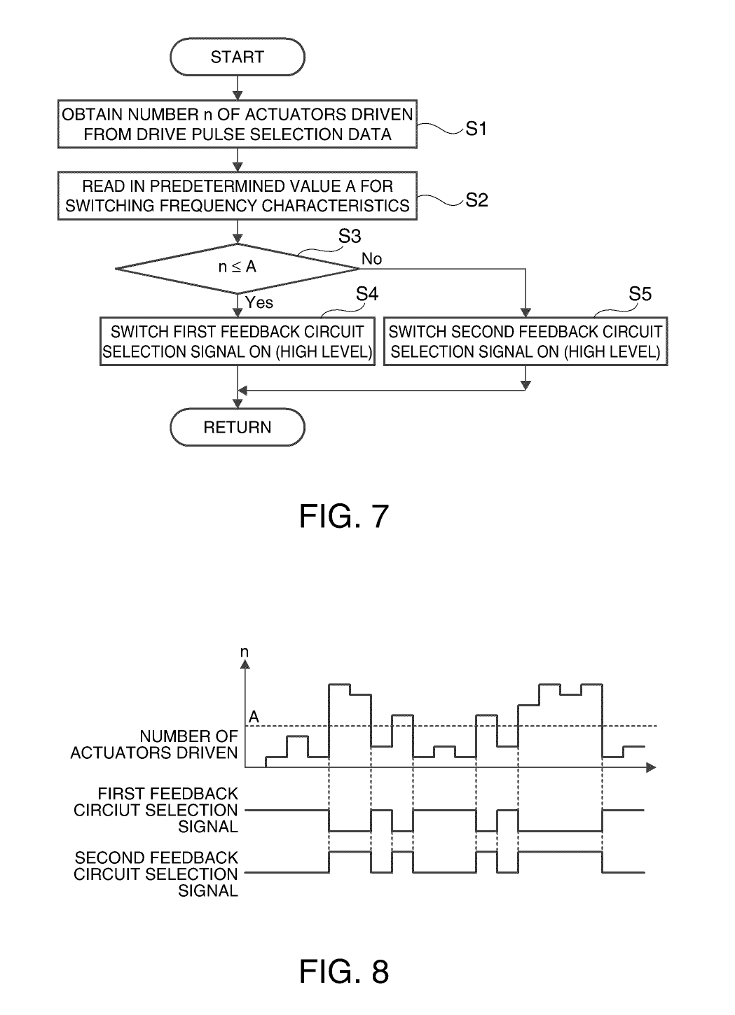

The adjusting section 204 performs the calculation process shown in FIG. 7 to control the switch 203. The adjusting section 204 may be configured with a program in the control section 13. The calculation process of FIG. 7 is performed prior to the output timing of the next drive signal COM (drive pulse PCOM). In Step S1, the number n of actuators to be driven is calculated from the drive pulse selection data SI. As described above, the drive pulse selection data SI indicates that the drive pulse PCOM is to be applied to the actuator 19 of which nozzles. The drive pulse selection data SI enables to obtain a number of the actuators 19 to be driven, or to put in another way, to obtain the number of the actuators 19 to which the drive pulse PCOM is to be applied.

Then in Step S2, a predetermined value A for switching frequency characteristics, which has initially been stored, is read in. A predetermined value A for switching frequency characteristics is, for example, a value equivalent to a half of all the actuators. Then in Step S3, whether the number n of the actuators to be driven calculated in Step S1 is equal to or less than the predetermined value A for switching frequency characteristics or not is judged. If the number n of the actuators to be driven is equal to or less than the predetermined value A for switching frequency characteristics, the flow proceeds to Step S4. If the number n of the actuators to be driven is greater than the predetermined value A for switching frequency characteristics, the flow proceeds to Step S5.

In Step S4, the first feedback circuit selection signal is turned on (high level) and the second feedback circuit selection signal is turned off (low level). Then, the flow proceeds back to the main program.

In Step S5, the second feedback circuit selection signal is turned on (high level) and the first feedback circuit selection signal is turned off (low level). Then, the flow proceeds back to the main program.

When the number n of the actuators to be driven chronologically varies as shown in FIG. 8, if the number n of the actuators to be driven is equal to or less than the predetermined value A for switching frequency characteristics, the first feedback circuit selection signal is at high level (the second feedback circuit selection signal is at low level), and the first feedback circuit 201 is connected to the negative feedback terminal of the subtractor 25. If the number n of the actuators to be driven is greater than the predetermined value A for switching frequency characteristics, the second feedback circuit selection signal is at high level (the first feedback circuit selection signal is at low level), and the second feedback circuit 202 is connected to the negative feedback terminal of the subtractor 25.

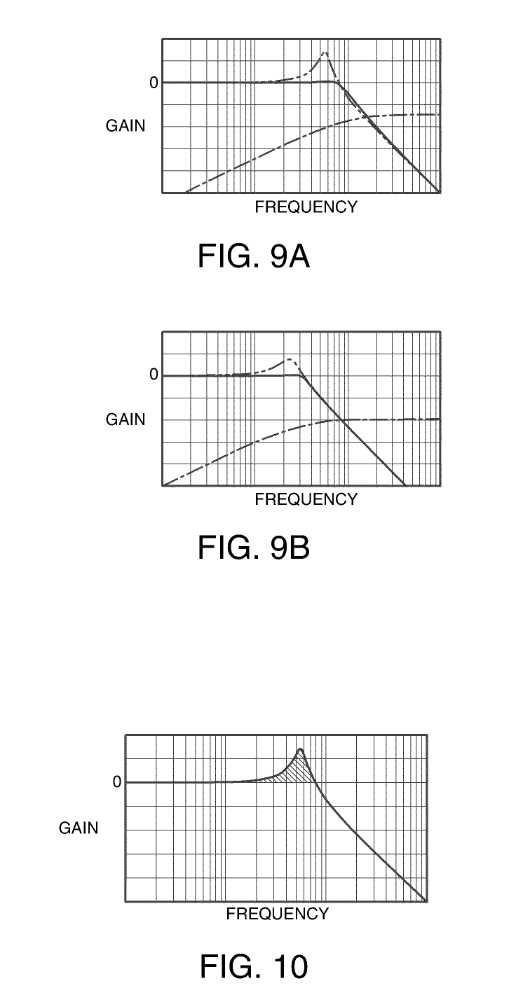

Shown in FIG. 9A are an output gain (frequency characteristics) when the number n of the actuators to be driven is equal to or less than the predetermined value A for switching frequency characteristics indicated by the solid line, a filter gain (frequency characteristics) constituted of the low pass filter 28 and the capacitances of the actuators 19 to be driven indicated by the chain double-dashed line, and a gain (frequency characteristics) of the first feedback circuit 201 to be selected indicated by the chain line. Shown in FIG. 9B are an output gain (frequency characteristics) when the number n of the actuators to be driven is greater than the predetermined value A for switching frequency characteristics indicated by the solid line, a filter gain (frequency characteristics) constituted of the low pass filter 28 and the capacitances of the actuators 19 to be driven indicated by the chain double-dashed line, and a gain (frequency characteristics) of the second feedback circuit 202 to be selected indicated by the chain line.

When the number of actuators driven is small as shown in FIG. 9A, a large-amplitude resonance occurs in higher frequencies. When the number of actuators driven is large as shown in FIG. 9B, a small-amplitude resonance occurs in lower frequencies. As shown in FIG. 9A, for the first feedback circuit 201 to be selected when the number n of the actuators to be driven is equal to or less than the predetermined value A for switching frequency characteristics, setting the gain in the high-pass range large and extending the low-cut range to a higher frequency range reduces the large-amplitude resonance in higher frequencies, and flattens the output gain of the filter, constituted of the low pass filter 28 and the capacitances of the actuators 19 to be driven, up to immediately before the high-cut range. As shown in FIG. 9B, for the second feedback circuit 202 selected when the number n of the actuators to be driven is greater than the predetermined value A for switching frequency characteristics, setting the gain in the high-pass range small and keeping the low-cut range within a low frequency range reduces the small-amplitude resonance in lower frequencies, and flattens the output gain of the filter, constituted of the low pass filter 28 and the capacitances of the actuators 19 to be driven, up to immediately before the high-cut range.

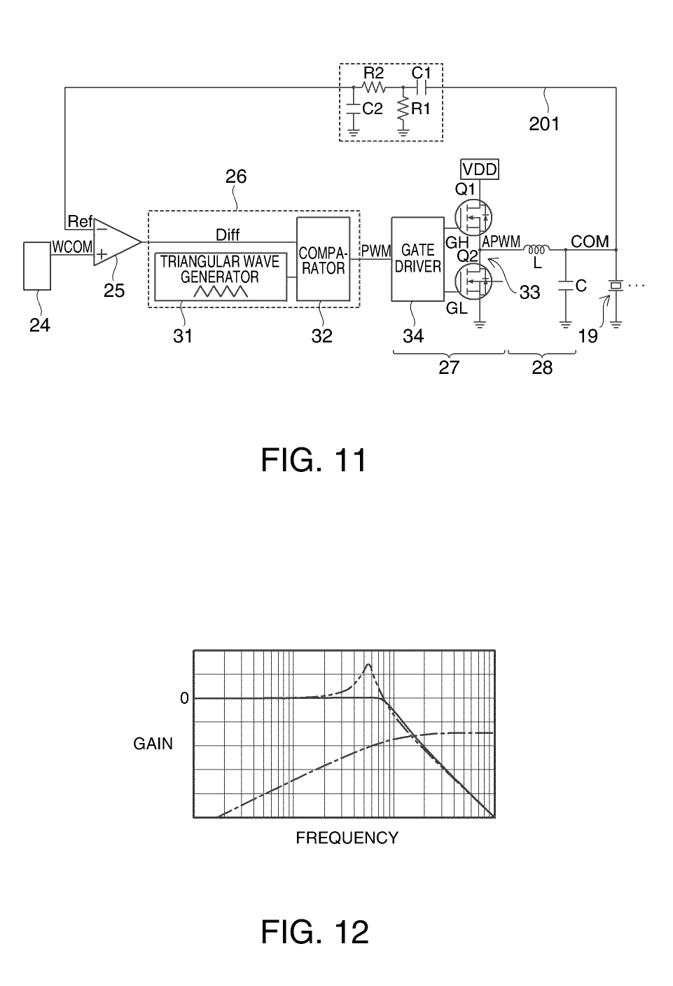

Configuration of the first feedback circuit 201 and the second feedback circuit 202 will be described below. In the secondary low pass filter constituting the low pass filter 28, no dumping resistance is interposed, and hence the resonance occurs in lower frequencies of the high-cut frequency range, as shown in FIG. 10. The resonance may be reduced using a feedback circuit illustrated in FIG. 11. As shown in FIG. 12, setting a gain (frequency characteristics) of the feedback circuit as indicated by the chain line reduces the resonance of a filter gain (frequency characteristics) constituted of the low pass filter 28 and the capacitances of the actuators 19 driven, as indicated by the chain double-dashed line, to obtain a flat output gain (frequency characteristics) that has no peak as indicated by the solid line.

Each of the actuators 19 is provided in each nozzle shown in FIG. 2. The drive signal COM (drive pulse PCOM) is applied to those actuators 19 that are connected by the switch 23 shown in FIG. 5 to drive the actuators 19 according to the drive signal COM (drive pulse PCOM) applied. The actuators 19 are capacitive loads, in other words, hold capacitance. In the low pass filter 28, the capacitance according to the number of the actuators 19 to be driven is connected in parallel to the capacitor C of the low pass filter 28. When the number of actuators 19 to be driven varies, frequency characteristics of the filter constituted of the low pass filter 28 and capacitance of driven actuators 19 also vary.

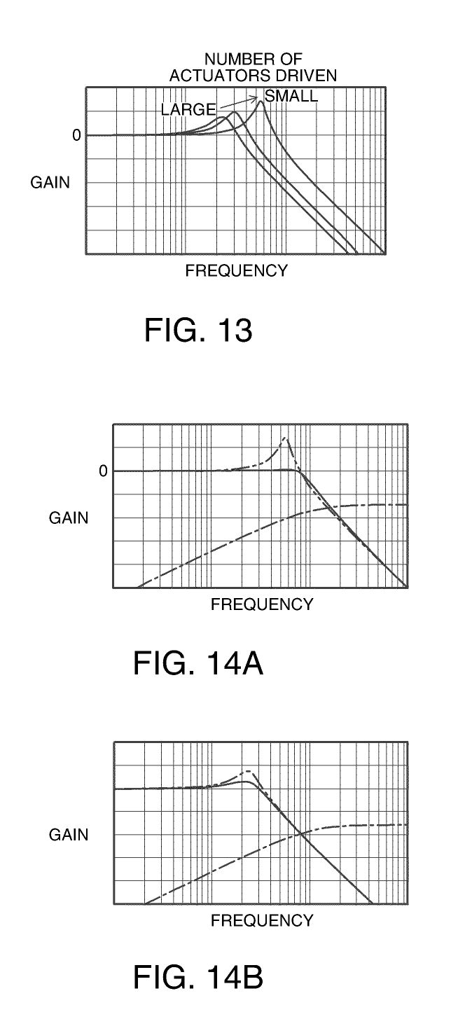

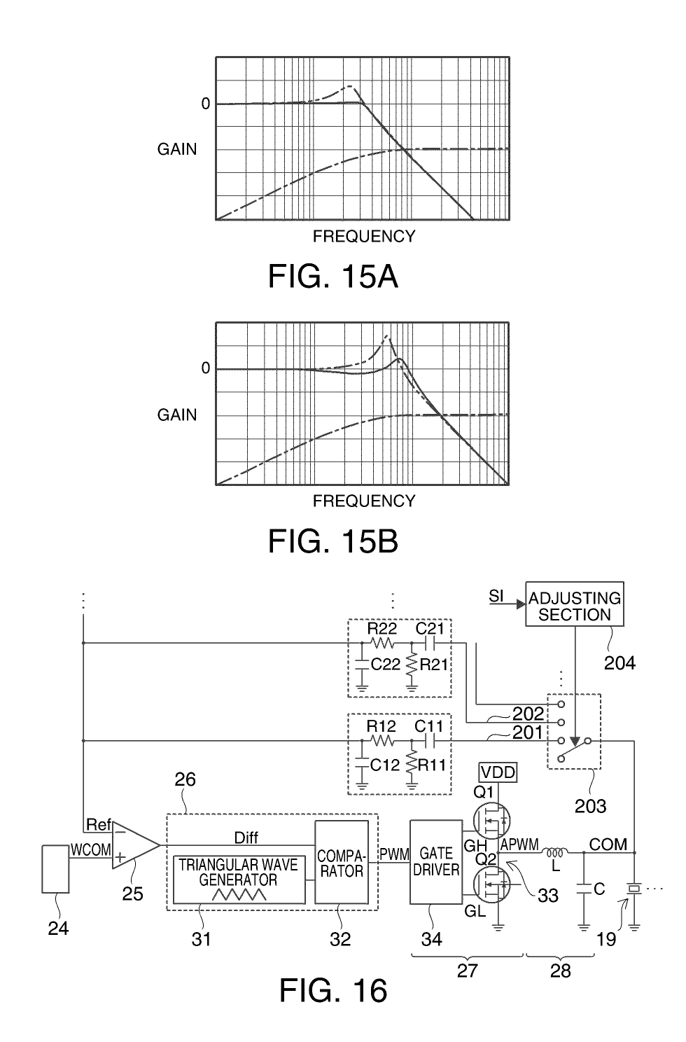

Shown in FIG. 13 is a variance in frequency characteristics of the filter constituted of the low pass filter 28 and capacitance of the actuators 19 to be driven when the number of actuators driven varies. As described above, a large-amplitude resonance occurs in higher frequencies when the number of actuators driven is small, and a small-amplitude resonance occurs in lower frequencies when the number of actuators driven is large. When dealing with such variance in frequency characteristics with a single feedback circuit as shown in FIG. 11, the frequency characteristics for the feedback circuit is to be configured as the chain line shown in FIG. 14A so as to accommodate the resonance when the number of actuators driven is small, as indicated by the chain double-dashed line shown in FIG. 14A, to achieve the output gain as indicated by the solid line. However, such configuration will not be able to reduce the resonance like the output gain as indicated by the solid line in FIG. 14B when the number of actuators driven is large, as indicated by the chain double-dashed line shown in FIG. 14B. On the other hand, when the frequency characteristics for the feedback circuit is to be configured as indicated by the chain line in FIG. 15A so as to accommodate the resonance when the number of actuators driven is large as indicated by the chain double-dashed line in FIG. 15A to achieve the output gain in the solid line, such configuration will not be able to reduce the resonance like the output gain as indicated by the solid line, or to keep the output gain flat when the number of actuators driven is small as indicated by the chain double-dashed line in FIG. 15B.

To deal with that, two feedback circuits with different frequency characteristics, namely the first feedback circuit 201 and the second feedback circuit 202, are provided. The first feedback circuit 201 and the second feedback circuit 202 are switched based on the number of actuators driven. Such configuration allows for reducing the resonance despite whether the number of actuators driven is small or large and for achieving a flat output gain. It should be noted that a driving circuit according to a second embodiment shown in FIG. 16 may be employed instead of the driving circuit of FIG. 6. In the driving circuit of FIG. 16, the switch 203 of the driving circuit of FIG. 6 is moved away from the subtractor 25 closer to the actuators 19. Such change in the configuration brings about the same advantage as the driving circuit of FIG. 6.

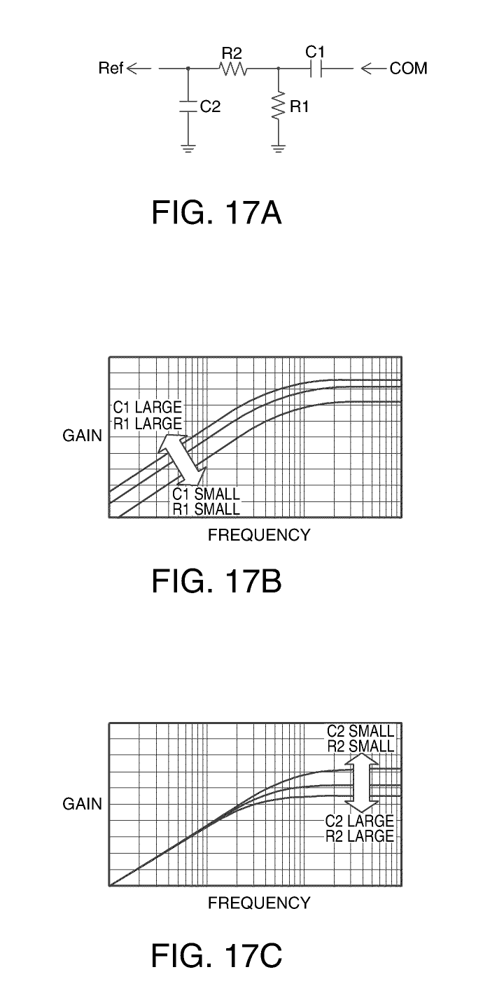

Next, configuration of the frequency characteristics of a feedback circuit is described below. Shown in FIG. 17A are elements in the feedback circuit. A capacitor denoted by C1 and a ground resistance denoted by R1 that constitute a high pass filter. A resistance denoted by R2, and a ground capacitor denoted by C2 that constitute a low pass filter. Increasing the capacitance of the capacitor C1 and the resistance value of the ground resistance R1 causes a larger gain as shown in FIG. 17B, and decreasing the capacitance of the capacitor C1 and the resistance value of the ground resistance R1 causes a smaller gain. Increasing the resistance value of the resistance R2 and the capacitance of the ground capacitor C2 causes a smaller gain in a high frequency range, and decreasing the resistance value of the resistance R2 and the capacity of the ground capacitor C2 causes a larger gain in a high frequency range. The feedback circuit elements may be configured so as to obtain a predetermined output gain when the frequency characteristics of the feedback circuit and the frequency characteristics of the filter constituted of the low pass filter 28 and the capacitance of the actuators 19 to be driven are combined. As such, in the first and second embodiments, it is possible to change the frequency characteristics of the feedback circuits switchable among one another and hence variance in the frequency characteristics of the filter constituted of the low pass filter 28 and the capacitance of actuators 19 to be driven is suppressed.

Other embodiments are described below. For other embodiments, the elements with the same or similar configuration as the embodiments already described above are referenced by the same numerals, and a detailed description thereof is omitted.

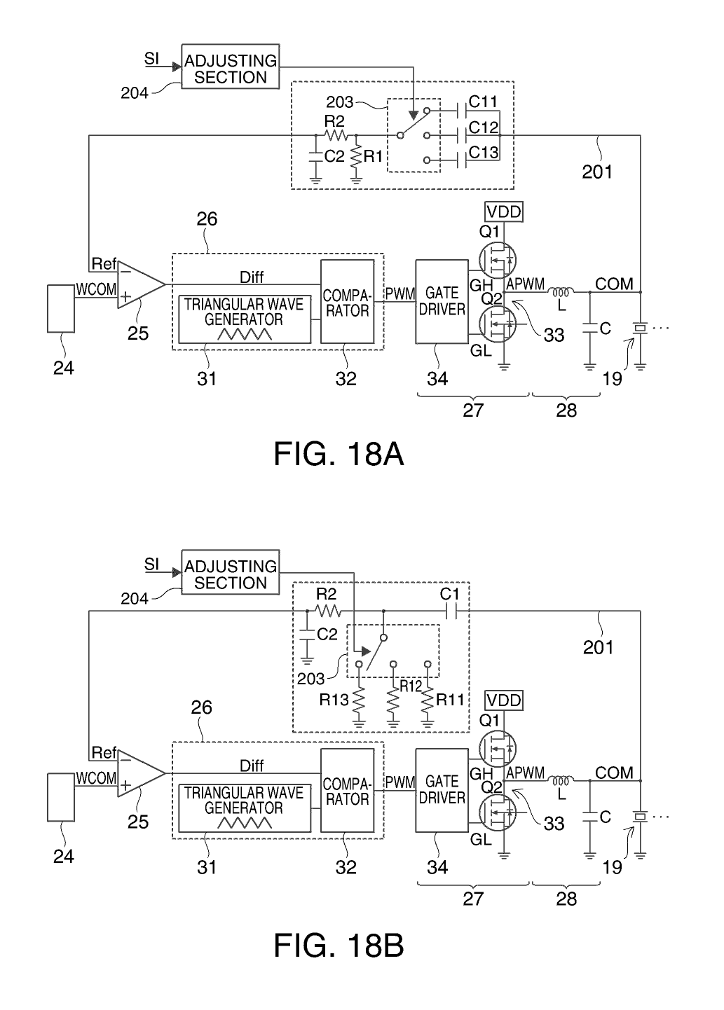

FIG. 18A is a block diagram showing a driving circuit in the head driver of FIG. 3 according to a third embodiment. FIG. 18B is a block diagram showing a driving circuit in the head driver of FIG. 3 according to a fourth embodiment. Although the first feedback circuit 201 of the first and second embodiments is employed in the third and fourth embodiments, the third embodiment shown in FIG. 18A includes three capacitors C11, C12, and C13 that constitute a high pass filter, and the capacitors C11, C12, and C13 are switchable by the switch 203. The fourth embodiment shown in FIG. 18B includes three ground resistances R11, R12, and R13 that constitute a high pass filter, and the resistances R11, R12, and R13 are switchable by the switch 203. The adjusting section 204 controls the switch 203.

In the first feedback circuit 201, adjusting or changing the resistance value, capacitance, or inductor component of one or more of the elements constituting a high pass or low pass filter enables the frequency characteristics (gain) of the first feedback circuit 201 to be adjusted or changed. In the case of FIG. 18A, it is provided that the capacitances of each of the capacitors C11, C12, and C13 constituting a high pass filter are different. In the case of FIG. 18B, it is provided that the resistance values of each of the ground resistances R11, R12, and R13 constituting a high pass filter are different. Changing the connection by switching among the capacitors C11, C12, and C13 or the ground resistances R11, R12, and R13 based on the number n of actuators to be driven using the adjusting section 204 enables the frequency characteristics of the first feedback circuit 201 to be switched, adjusted or changed.

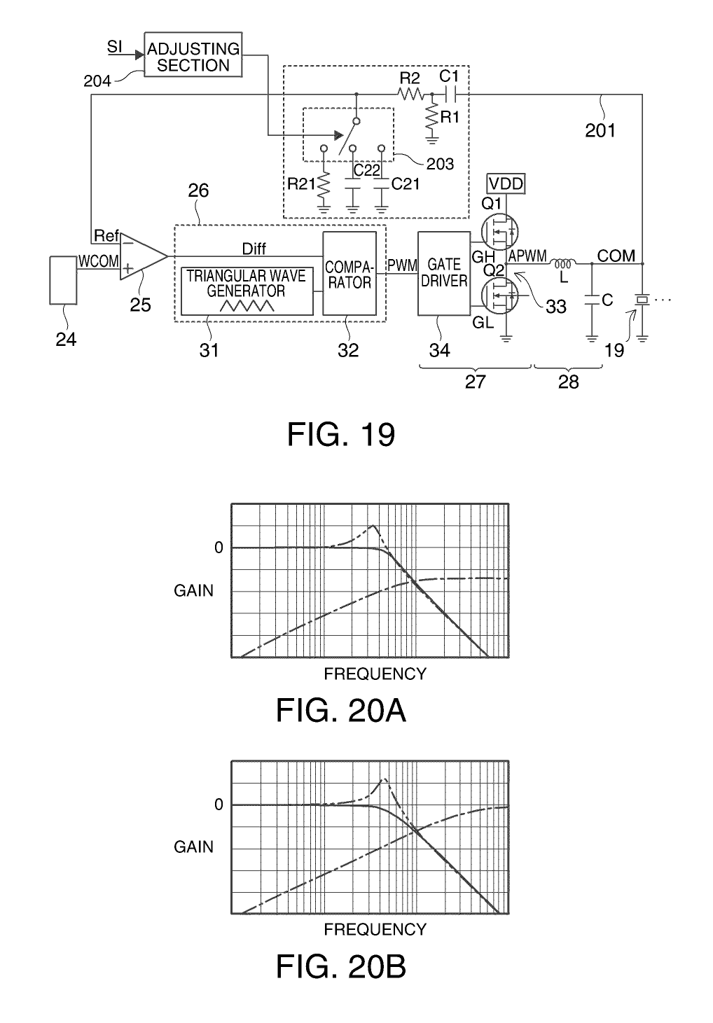

FIG. 19 is a block diagram showing a driving circuit in the head driver of FIG. 3 according to a fifth embodiment. In the fifth embodiment, instead of the high pass filter of FIG. 18, two ground capacitors C21 and C22, and a ground resistance R21 are connected in parallel to a ground capacitor that constitutes a low pass filter. The ground capacitors C21 and C22, and the ground resistance R21 are switchable by the switch 203. The adjusting section 204 controls the switch 203. The capacitances of the two ground capacitors C21 and C22 are different, and the ground resistance R21 is of a high resistance value. The adjusting section 204, when the number n of actuators to be driven requested by the drive pulse selection data SI is large, connects either one of the two ground capacitors C21 and C22. When the number n of actuators to be driven is small, the adjusting section 204 connects the ground resistance R21 having a high resistance value.

As to the frequency characteristics of the filter constituted of the low pass filter 28 and capacitance of actuators 19 driven when the number n of actuators to be driven is large, the resonance is in lower frequencies and its amplitude is small. Hence, the frequency characteristics of the first feedback circuit 201 should be configured so as to reduce the resonance and not to excessively feed back signals in the frequency range of the resonance frequency or higher. In other words, the high-cut frequency should not be set too high depending on a feedback signal. Hence, a low pass filter is interposed, as described in relation to FIG. 17C, to set the capacitance of the ground capacitance of the low pass filter. As a result, setting the frequency characteristics (gain) of the first feedback circuit 201 as indicated by the chain line in FIG. 20A reduces the resonance which occurs when the number n of actuators to be driven is large as indicated by the chain double-dashed line, and increases the output gain of the higher frequency range than the resonance frequency, as indicated by the solid line in FIG. 20A to flatten the gain characteristics.

As to the frequency characteristics of the filter constituted of the low pass filter 28 and capacitance of actuators 19 driven when the number n of actuators to be driven is small, the resonance is in higher frequencies and its amplitude is large. Hence, the frequency characteristics of the first feedback circuit 201 may be configured so as to set the high-cut frequency to adequately feed back signals in the resonance frequency or higher including the resonance. Ultimately, a low pass filter is not even necessary. When the number n of actuators to be driven is small, the ground capacitor of the high pass filter of the first feedback circuit 201 is turned on to connect to the ground resistance R21 that has a high resistance value to increase the gain in the high frequency range of the first feedback circuit 201 as indicated by the chain line in FIG. 20B. As a result, such configuration sufficiently reduces the range over the resonance frequency including the resonance when the number n of actuators to be driven is small, as indicated by the chain double-dashed line in FIG. 20B, to flatten the output gain as shown in the solid line in FIG. 20B. As such, the third to the fifth embodiments enable to decrease the number of feedback circuits to achieve a smaller circuit scale.

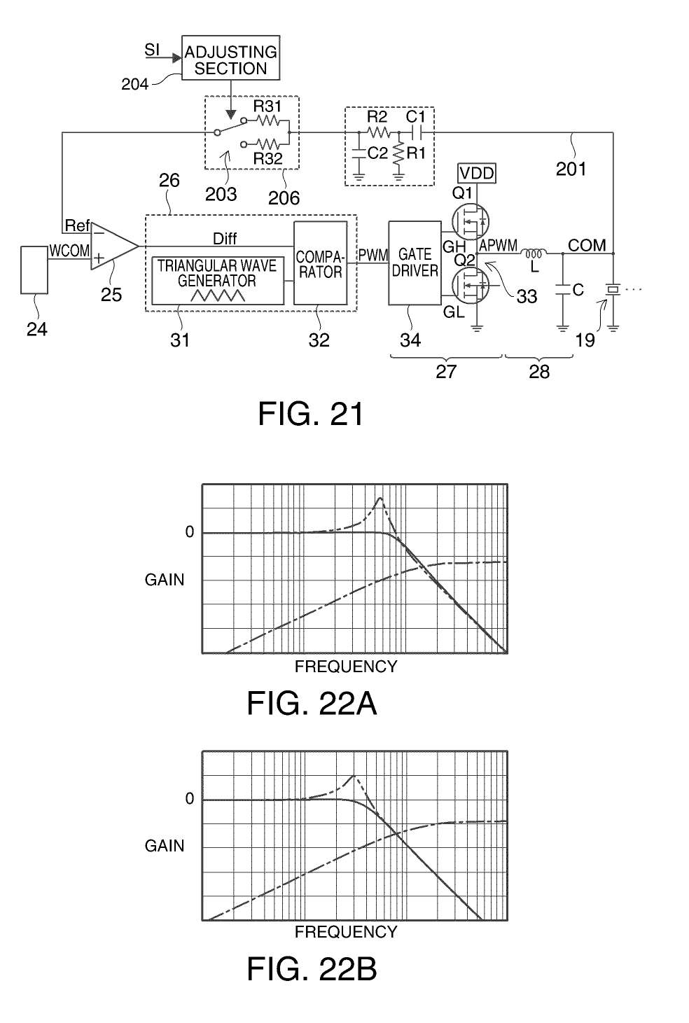

FIG. 21 is a block diagram showing a driving circuit in the head driver of FIG. 3 according to a sixth embodiment. The first feedback circuit 201 is used in the sixth embodiment similarly to the third to fifth embodiments. The first feedback circuit 201 is configured to include a high pass filter constituted of a capacitor C1 and a ground resistance R1, and a low pass filter constituted of a resistance R2 and a ground capacitor C2. In the sixth embodiment, interposed between the subtractor 25 and the combination of the high pass filter and the low pass filter is a gain adjusting unit 206 that adjusts a gain of the first feedback circuit 201. The gain adjusting unit 206 is configured to include two resistances R31 and R32 having different resistance values parallely disposed to each other. The switch 203 switches between the resistance R31 and resistance R32 to connect either one to the subtractor 25. The adjusting section 204 controls the switch 203. When the resistance value of the connected resistance R31 or resistance R32 becomes large, the gain of the first feedback circuit 201 becomes small.

The frequency characteristics of the first feedback circuit 201 are indicated by the chain line in FIG. 22A when either of the resistance R31 or resistance R32 having a larger resistance value is connected. Assumed herein is that, when the frequency characteristics of the first feedback circuit 201 are as indicated by the chain line in FIG. 22A, adequately reducing the resonance when the number n of actuators to be driven is small as indicated by the chain double-dashed line in FIG. 22A, enables to obtain a flat output gain as indicated by the solid line in FIG. 22A. As to the frequency characteristics of the first feedback circuit 201 shown in the chain line in FIG. 22A, when the number n of actuators to be driven becomes large, the resonance moves toward lower frequencies and the gain of the first feedback circuit 201 may not be able to sufficiently reduce the resonance. To deal with that, the gain adjusting unit 206 should be set, when the number n of the actuators to be driven is large, so as to connect either of the resistance R31 or the resistance R32 having a smaller resistance value and to increase the gain of the first feedback circuit 201 as indicated by the chain line in FIG. 22B. Such configuration allows to adequately reduce the resonance that has moved to the lower frequencies as indicated by the chain double-dashed line to achieve the flat output gain as indicated by the solid line in FIG. 22B. Hence, the sixth embodiment enables to decrease the number of feedback circuits to achieve a smaller circuit scale.

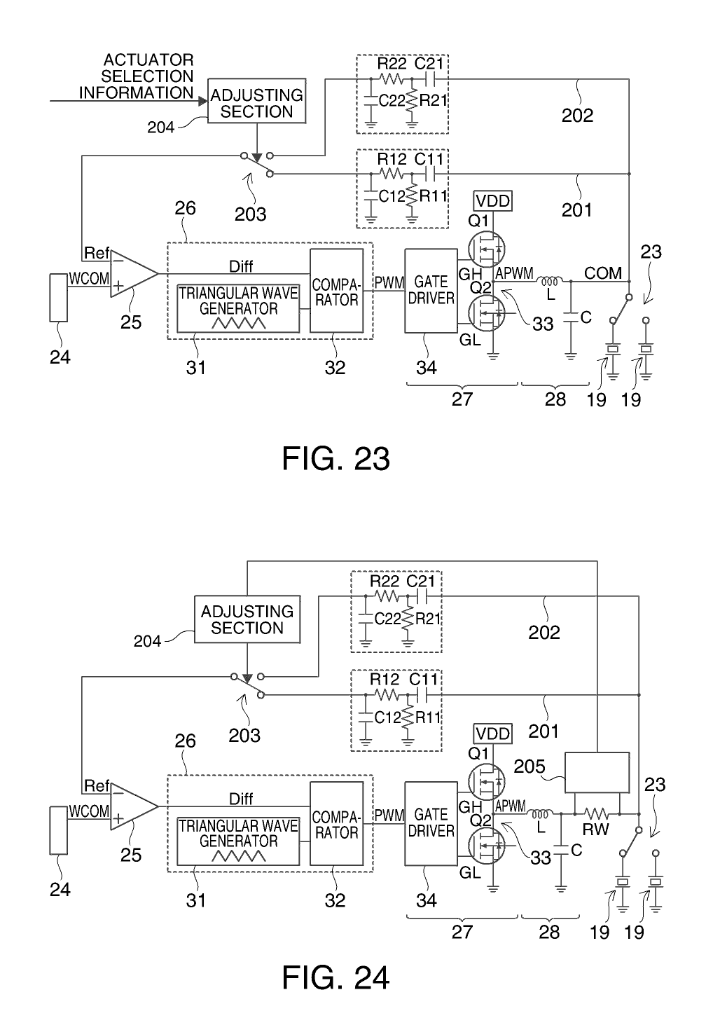

FIG. 23 is a block diagram showing a driving circuit in the head driver of FIG. 3 according to a seventh embodiment. The seventh embodiment may be applicable to a case where there are two actuators 19, capacitances of which are different. Either one of the two actuators 19 is connected to the driving circuit by the switch 23. It has been described that a single actuator corresponds to a single inkjet head, but a single inkjet head may be provided with a plurality of actuators. For example, a plurality of inkjet heads with differing capacitances may be replaced with or switched to one another. The seventh embodiment is configured to include the first feedback circuit 201 and the second feedback circuit 202 with different frequency characteristics, similarly to the first embodiment. The adjusting section 204 controls the switch 203 based on actuator selection information which indicates which of the actuators 19 is selected. Configuration of the frequency characteristics of the first feedback circuit 201 and the second feedback circuit 202 should be such that either of the actuators 19 with a larger capacitance corresponds to a case of the first embodiment where the number n of actuators to be driven is large, and the other of the actuators 19 with a smaller capacitance corresponds to a case of the first embodiment where the number n of actuators to be driven is small.

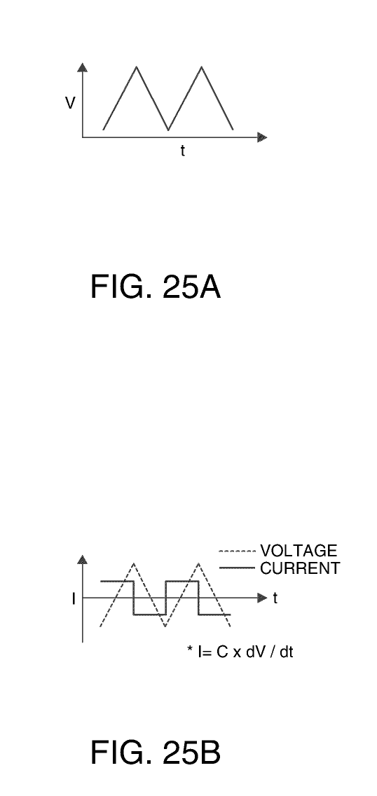

FIG. 24 is a block diagram showing a driving circuit in the head driver of FIG. 3 according to an eighth embodiment. A circuit configuration of the eighth embodiment is substantially the same as that of the seventh embodiment, except that a current-detecting resistance Rw is interposed on an output terminal of the drive signal COM (drive pulse PCOM). The current caused in the terminals of the current-detecting resistance Rw is detected in a current-detecting circuit 205. The adjusting section 204 controls the switch 203 based on the current value detected in the current-detecting circuit 205. In order for the current-detecting circuit 205 to detect the current of the drive signal COM (drive pulse PCOM), in the eighth embodiment, the drive waveform generator 24 generates a triangular-wave voltage signal, shown in FIG. 25A, to enable detection of the current. As shown in FIG. 25B, the triangular-wave voltage signal has a positive and constant current value when the voltage increases, and has a negative and constant current value when the voltage decreases. Hence, comparing either of the positive or negative values, or an absolute value to a threshold B gives capacitance of the connected actuators 19. As for determining the threshold B, for example, when the tolerance of the load of the capacitance of the actuators 19 is ±30%, with one capacitance being Cα and the other capacitance being Cβ where Cα<Cβ stands true, the threshold B may be set within a range where the following equation stands true:

Cα×1.3×dV/dt<B<Cβ×0.7×dV/dt

If the detected current value is greater than the threshold B, the capacitance Cβ is connected. If the detected current value is less than the threshold B, the capacitance Cα is connected.

In the capacitive load driving device and inkjet printer described above, as the drive signal COM (drive pulse PCOM) is applied to the actuator 19 constituted of a capacitive load such as a piezoelectric element, the difference signal Diff from the subtractor 25 between the drive waveform signal WCOM and the feedback signal Ref is pulse-modulated to be output as a modulated signal PWM. The modulated signal PWM is then amplified in the digital power amplifier 27 to be output as an amplified digital signal APWM. The amplified digital signal APWM is smoothed in the low pass filter 28 to be output as a drive signal COM (drive pulse PCOM) of the actuator 19. The drive signal COM (drive pulse PCOM) is fed back from the feedback circuits 201 and 202 as a feedback signal Ref. Then, adjusting the frequency characteristics of the feedback circuits 201 and 202 according to the capacitance of the actuator(s) 19 to be driven by the drive signal COM (drive pulse PCOM) enables variance in the frequency characteristics of the filter, constituted of the low pass filter 28 and the capacitance of the actuator 19 to be driven, to be suppressed without using dummy loads. Such configuration enables highly precise printing as a result.

In some of the embodiments described above, the capacitive load driving device employed in a line-head inkjet printer has been described in detail. The capacitive load driving device may be employed in a multi-path inkjet printer as well.

In some other embodiments described above, the capacitive load driving device employed to drive the actuator, which is a capacitive load in the inkjet printer has been described in detail. The capacitive load driving device may be employed in an apparatus that ejects fluid as well. For example, a water-pulse scalpel suitable to be disposed on a tip of a catheter and inserted into a blood vessel to remove a blood clot or the like, or suitable for dissecting or removing living tissue. The water-pulse scalpel ejects liquid including water or normal saline.

The water-pulse scalpel ejects liquid in pulse-flow, which is supplied under high pressure from a pump. In order to eject liquid in pulses, a piezoelectric element, which is a capacitive load, is driven to deform a diaphragm that constitutes a fluid chamber to generate a pulse-flow. In the water-pulse scalpel, the piezoelectric element, which is a capacitive load, and a fluid-ejection control section are disposed away from each other. Employing the capacitive load driving device in the water-pulse scalpel enables a highly-precise drive signal for the capacitive load. As a result, it enables a highly-precise control over fluid ejection.

A fluid jet apparatus that uses the capacitive load driving device may eject ink, normal saline or other liquid (including functional material particles dispersed in a liquid form, or fluid material such as gel), or other fluids besides liquid. For example, the fluid jet apparatus may eject liquid that includes dispersed or dissolved material such as color or electrode materials that are used to manufacture a liquid crystal display, electroluminescence display, surface-emitting display, or color filter. The fluid jet apparatus may also eject a living organic matter that is used for producing a biochip. The fluid jet apparatus may also eject a liquid sample to be used for a micropipette. The fluid jet apparatus may also eject lubricant oil to a very precise location on precision products such as a watch or camera. The fluid jet apparatus may also eject on a substrate clear resin such as ultraviolet-curable resin that is used to form a micro hemisphere lens (optical lens) for optical communication elements. The fluid jet apparatus may also eject etchant that is acid or alkaline for etching a substrate or the like. The fluid jet apparatus may also eject gel. The fluid jet apparatus may be used as a fluid jet type recording apparatus that ejects powder such as toner. The present invention is applicable to any one of the above fluid jet apparatuses.

What is claimed is:

1. A capacitive load driving device comprising:
a drive waveform generator that generates a drive waveform signal;
a subtractor that outputs a difference signal between the drive waveform signal and a feedback signal;
a modulator that pulse-modulates the difference signal to output a modulated signal;
a digital power amplifier that amplifies the modulated signal to output an amplified digital signal;
a low pass filter that smoothes the amplified digital signal to output a drive signal for a capacitive load;
a feedback circuit that outputs the feedback signal obtained from the drive signal; and
an adjusting section that adjusts frequency characteristics of the feedback circuit based on capacitance of the capacitive load to be driven.

2. The capacitive load driving device according to claim 1, further comprising:
a second feedback circuit with different frequency characteristics from the feedback circuit, and
the adjusting section switches between the feedback circuit and the second feedback circuit based on the capacitance of the capacitive load to be driven.

3. The capacitive load driving device according to claim 1, wherein the feedback circuit includes a first element and a second element, both of which are used to adjust the frequency characteristics, and
the adjusting section switches between the first element and the second element based on the capacitance of the capacitive load to be driven.

4. The capacitive load driving device according to claim 1, wherein the feedback circuit includes a gain adjusting section that adjusts gain characteristics relative to a frequency, and
the adjusting section adjusts the gain characteristics of the feedback circuit based on the capacitance of the capacitive load to be driven.

5. A liquid jet apparatus comprising:
the capacitive load driving device according to claim 1; and
an actuator that is the capacitive load to be driven by the capacitive load driving device.
